(19) United States
(12) Patent Application Publication
(10) Pub. No.: US 2011/0161048 A1
(43) Pub. Date: Jun. 30, 2011

(54) Method to Optimize Prediction of Threshold Violations Using Baselines

(75) Inventors: Sridhar Sodem, Cupertino, CA (US); Derek Dang, San Jose, CA (US); Alex Lefaive, Sunnyvale, CA (US); Joe Scarpelli, Mountainview, CA (US)

(73) Assignee: BMC SOFTWARE, INC., Houston, TX (US)

(21) Appl. No.: 12/750,347

(22) Filed: Mar. 30, 2010

Related U.S. Application Data
(60) Provisional application No. 61/291,409, filed on Dec. 31, 2009.

(51) Int. Cl. G06F 17/18; G06F 15/00

(52) U.S. Cl. 702/181; 702/182

(57) ABSTRACT

A baseline technique allows reducing the number of threshold violation predictions that need to be generated in a performance monitoring system. One or more baselines may be calculated based on long-term trends in a monitored metric. If the metric is within the baseline, then predictions regarding short-term trends in the metric may be omitted. If the metric is outside the baseline, then short-term trends may be analyzed to predict possible threshold violations.

### CROSS-REFERENCE TO RELATED APPLICATIONS

This Application claims priority to U.S. Provisional Application Ser. No. 61/291,409 entitled “Method to Optimize Prediction of Threshold Violations Using Baselines” filed Dec. 31, 2009, which is incorporated by reference in its entirety herein.

### BACKGROUND

This disclosure relates generally to the field of computer systems. More particularly, but not by way of limitation, it relates to a technique for improving performance monitoring systems.

One common function performed by an information technology (IT) organization of an enterprise is to monitor the performance of the IT infrastructure. A typical enterprise-wide infrastructure includes database servers, web servers, application servers etc. and network devices like routers, switches etc. Performance monitoring of such an infrastructure may involve monitoring a very large number of metrics, with the need to monitor over a million metrics in many enterprises. Subsets of these monitored metrics, which may often include multiple hundreds of thousands of metrics, are often considered important enough to define conditions that trigger alarms for operators. Some of these alarms may be static absolute thresholds set for a metric, where exceeding the threshold triggers an alarm for an operator to take action to attempt to correct whatever has caused the alarm. In addition to static thresholds, monitoring systems often employ dynamic thresholds, sometimes in conjunction with static thresholds for at least some of the monitored metrics.

Waiting for a metric to cross an alarm threshold is often considered insufficient, and advance warning or prediction of potential threshold violations may be valuable to allow operators to take actions to attempt to prevent actual threshold violations. In some monitoring systems that use predictive techniques, an early warning or predictions of a threshold violation may indicate an expected time to the predicted threshold violation conditions. For example, where slow performance degradations are occurring, a warning that indicates the operators have an estimated ten minutes to resolve whatever is causing the problem may be valuable in helping operators determine what actions should or can be taken.

These early warnings need to be accurate and timely. False or delayed predictions will adversely affect the efficiency of operators managing the IT infrastructure. False predictions may cause operators to take unnecessary actions that may cause other problems, and delayed predictions may not warn operators of problems with sufficient lead time to take the necessary preemptive actions. But analyzing short-term (under six hours into the future) trends of performance data being collected for hundreds of thousands of metrics in real time and generating accurate predictions without any delays or false predictions has been a problem for performance monitoring systems.

### SUMMARY

In one embodiment, a method is disclosed. The method comprises collecting data corresponding to a metric of an information technology system; setting a threshold value corresponding to the metric; generating a baseline corresponding to the metric; and generating a prediction that the metric will violate the threshold only if the data corresponding to the metric is outside of the baseline.

In another embodiment, a performance monitoring system is disclosed. The performance monitoring system comprises a processor; an operator display, coupled to the processor; a storage subsystem, coupled to the processor; and a software, stored by the storage subsystem, comprising instructions that when executed by the processor cause the processor to perform the method described above.

In yet another embodiment, a non-transitory computer readable medium is disclosed. The non-transitory computer readable medium has instructions for a programmable control device stored thereon wherein the instructions cause a programmable control device to perform the method described above.

In yet another embodiment, a networked computer system is disclosed. The networked computer system comprises a plurality of computers communicatively coupled, at least one of the plurality of computers programmed to perform at least a portion of the method described above wherein the entire method described above is performed collectively by the plurality of computers.

In yet another embodiment, a method is disclosed. The method comprises: collecting data by a computer-implemented performance monitoring system corresponding to a metric of an information technology system during a first measurement period; setting a threshold value corresponding to the metric; generating a first baseline value for the first measurement period corresponding to a first condition; generating a second baseline value for the first measurement period corresponding to a second condition, wherein the first baseline value and the second baseline value define a baseline range for the first measurement period; calculating a trend of the data corresponding to the metric collected during a measurement period; and generating a prediction that the metric will violate the threshold only if a statistically significant number of data values collected during the first measurement period corresponding to the metric are outside of the baseline range and the trend is toward the threshold.

In yet another embodiment, a method is disclosed. The method comprises collecting data by a computer-implemented performance monitoring system corresponding to a metric of an information technology system during a first measurement period; generating a first baseline value for the first measurement period corresponding to a first condition; generating a second baseline value for the first measurement period corresponding to a second condition, wherein the first baseline value and the second baseline value define a baseline range for the first measurement period; calculating a third baseline value for a second measurement period responsive to the first baseline value for the first measurement period and the data collected during the first measurement period; and calculating a fourth baseline value for the second measurement period responsive to the second baseline value for the first measurement period and data collected during the first measurement period.

### BRIEF DESCRIPTION OF THE DRAWINGS

FIG. 1 illustrates, in graph form, an example of a measured metric on which a prediction can be made according to the prior art.

FIG. 2 illustrates, in graph form, an example of a graph according to one embodiment of a technique for using baselines for improving predictions of threshold violations.

FIG. 3 illustrates, in graph form, another example of a graph according to one embodiment of a technique for using baselines for improving predictions of threshold violations.

FIG. 4 illustrates, in graph form, yet another example of a graph according to one embodiment of a technique for using baselines for improving predictions of threshold violations.

FIG. 5 illustrates, in tabular form, an example of data collected by a performance monitor according to one embodiment.

FIG. 6 illustrates, in block diagram form, an example of relationships between baselines computed according to one embodiment.

FIG. 7 illustrates, in graph form, an example of relationships between baselines computed according to one embodiment.

FIGS. 8-10 illustrate, in tabular form, examples of data collected by a performance monitor according to one embodiment and baselines derived from the collected data.

FIG. 11 illustrates, in flowchart form, a technique for determining whether to predict threshold violations according to one embodiment.

FIG. 12 illustrates, in block diagram form, an example computer system used for performing a technique for predicting threshold violations according to one embodiment.

FIG. 13 illustrates, in block diagram form, an example IT infrastructure monitored using a technique for predicting threshold violations according to one embodiment.

### DETAILED DESCRIPTION

Various embodiments of the present invention provide techniques for improving the ability to predict threshold violations by generating baseline information for a monitored metric. When the metric monitored in real time is within the baselines computed for that metric, the monitoring system may ignore trends in the monitored data that might otherwise trigger a warning of a threshold violation. When the metric passes a baseline, then the metric may be monitored more closely for a potential threshold violation. The use of one or more baselines may thus eliminate unnecessary warnings, while preserving the ability to provide timely warnings of trends in the monitored data that are outside of a safe region. The baselines may be dynamically adjusted according to longer term trends in the monitored metric than typically used for predicting threshold violations.

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts are understood to reference all instance of subscripts corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

In the following discussion, any technique for making a prediction based on short-term trends in metric data may be used, and the specific prediction technique used is outside the scope of the present invention. For purposes of this discussion, a short term trend is typically under six hours into the future and is computed using only a limited most recent portion of the metric data, but any desired future time and past data considered amounts may be used as desired. As used herein, an absolute or static threshold value is a predefined fixed threshold value, in contrast to a dynamic threshold value that varies, typically over time, and which may be a value that is a function of one or more other values. Although the embodiments discussed below are described with absolute thresholds, the techniques disclosed herein may be used with dynamic thresholds, as well as absolute or static thresholds.

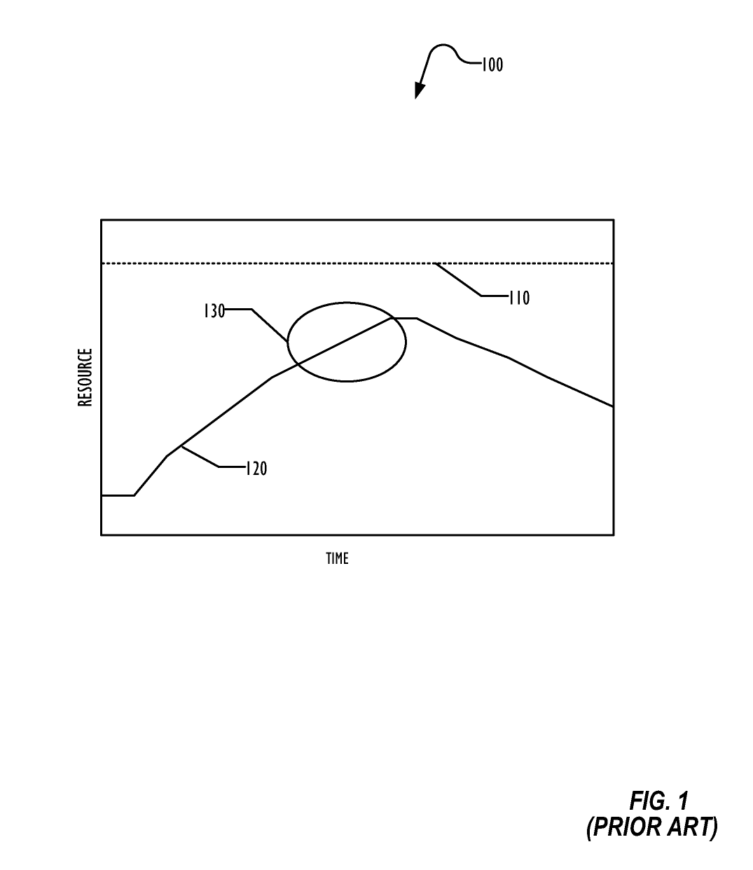

FIG. 1 is an example graph 100 of a single metric 120 according to the prior art. The metric is monitored for crossing a static threshold value 110. The metric might be memory usage or any other resource that is monitored by the performance monitoring system. In this graph, by just relying on the short-term trend of the data in area 130, due to lack of knowledge of the behavior of the metric over a longer period of time, a prediction may have been made that the metric was about to violate the absolute threshold 110. But the actual data collected indicates that such a prediction would have been false, since shortly after the area 130, the metric's curve flattened and the metric value then began to decrease.

Making predictions based on short-term metric data trends is resource intensive. Analyzing short-term trends of the data being collected for hundreds of thousands metrics in real time and generating predictions without any delays and avoiding false predictions is a daunting challenge. By reducing the number of predictions required, as well as reducing the number of false predictions, embodiments can substantially improve the ability of performance monitoring systems to scale to handle the number of metrics that an enterprise may desire to monitor.

In various embodiments, a baseline may be computed for each metric to capture the trend over a long period. To reduce the amount of resources needed for making predictions, the prediction algorithm for each metric is invoked only when the data being collected is outside the baseline. By doing so, incoming data may be processed much faster and the efficiency of the prediction engine is increased significantly. In addition, false predictions may be reduced dramatically as they are generated only when the data is outside its normal range, as indicated by the baseline.

If data for a metric falls within the computed baseline, the metric may be considered to be in a normal state, regardless of the static threshold, and no predictions need to be made for that metric. The present discussion assumption is that the static threshold is outside the baseline values. If the static threshold is within the baseline values, then that may indicate a problem to be addressed in a different way. Predictions are typically made for slowly degrading metrics where there is some room before absolute thresholds are violated, but the present invention is not limited to use with slowly degrading metrics. The metric curve may be considered to be outside of a baseline whenever the metric curve passes the baseline in the direction of the threshold.

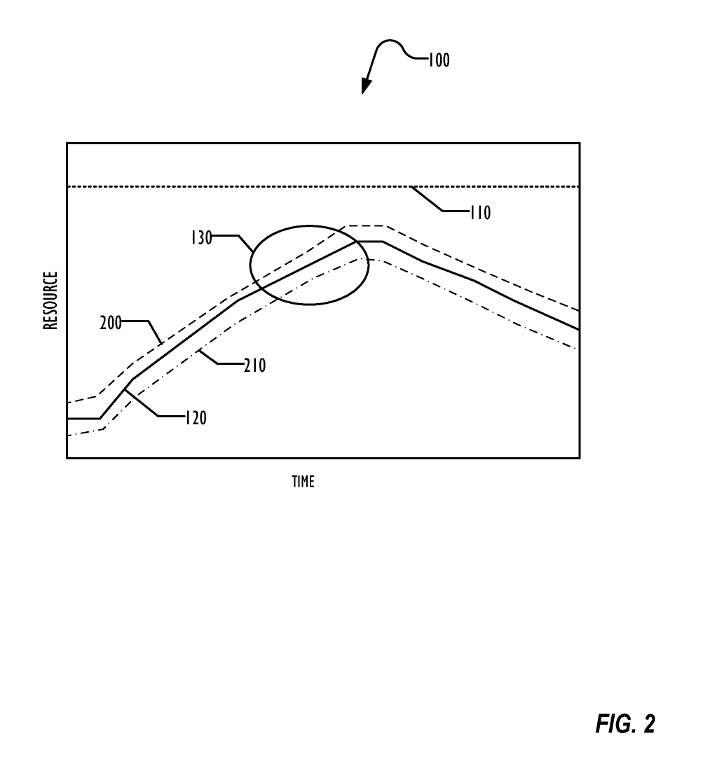

FIG. 2 is the same graph 100 of FIG. 1, with the addition of two example baseline value curves 200 and 210 according to one embodiment. As can be seen in FIG. 2, even though the short-term trend in the data in area 130 indicates that the metric 120 is going to violate the absolute threshold 110, the metric 120 is within the baselines 200 and 210. Because the metric 120 is within the baseline range defined by baseline curves 200 and 210, the short-term trend in area 130 is not of any concern and may be safely ignored, and the prediction made in the prior art system of FIG. 1 may be omitted, thus reducing false predictions.

In one embodiment, two baseline curves 200 and 210 are generated, and different actions may be taken depending on whether the metric curve 120 is between the two curves 200 and 210 or is outside of the range defined by the two curves. In another embodiment, a single baseline curve may be used instead of two baseline curves, and different actions may be taken depending on whether the metric curve 120 is below or above the single baseline curve. In some embodiments, where a metric may have both a high threshold and a low threshold, a first prediction may be made regarding whether the metric curve 120 will pass the high threshold and a second prediction may be made regarding whether the metric curve will pass the low threshold. In such embodiments, the first prediction may be omitted unless the metric curve 120 is above the high baseline curve 200 and the second prediction may be omitted unless the metric curve 120 is below the low baseline curve 210.

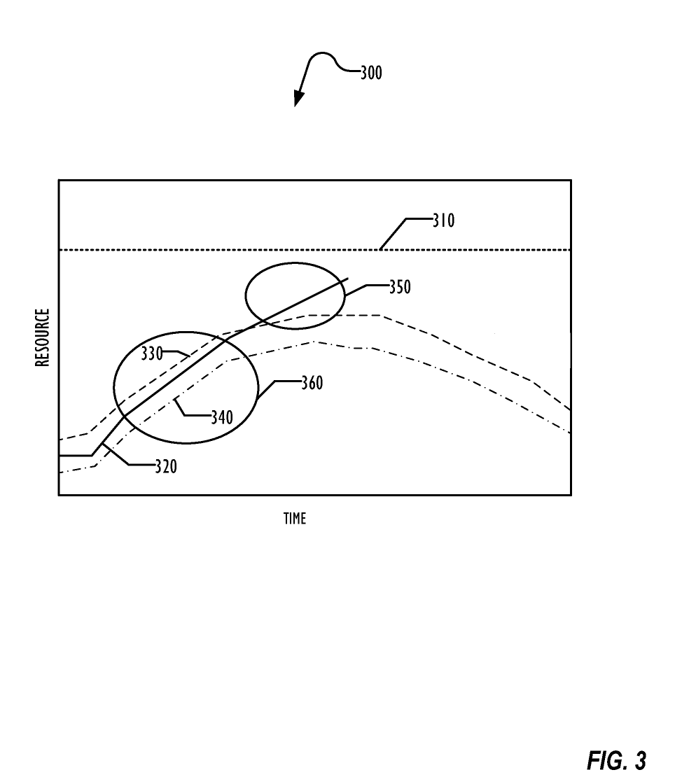

FIG. 3 is an example graph 300 according to a system according to one embodiment in which a metric curve 320 is analyzed for possible violations of the threshold 310. When the metric 320 is within the baseline range defined by high baseline curve 330 and low baseline curve 340, predictions regarding violation of the threshold 310 may be omitted. But when the metric curve 320 exceeds the upper baseline curve 330, as it does in area 350, then the prediction algorithm used by the performance monitoring system may generate a prediction of whether the metric curve 320 will violate the threshold 310. Because the metric curve 320 in the area 350 is outside of the normal baseline range for that metric, then a prediction generated based on the short-term trend in area 350 is more likely to be valid. In this example, the slope of the metric curve 320 in area 360 is actually higher than the slope of the metric curve 320 in area 350. Therefore, without the consideration of the baseline range defined between curves 330 and 340, a false prediction might have been made that the metric would violate threshold 310 in area 360.

By using the baseline to limit when predictions are made, the overall scalability of the performance monitoring system in processing millions of metrics may be improved and more valid predictions are made, with fewer false predictions, avoiding unnecessary actions that may be taken when a prediction falsely indicates a threshold violation is about to occur.

The baseline curves 330 and 340 described above are similar to the lane or shoulder lines. As long as the metric stays within the baseline curves, then predictions on whether the metric will violate a threshold may be omitted, and may be made when the metric is outside of the baseline range.

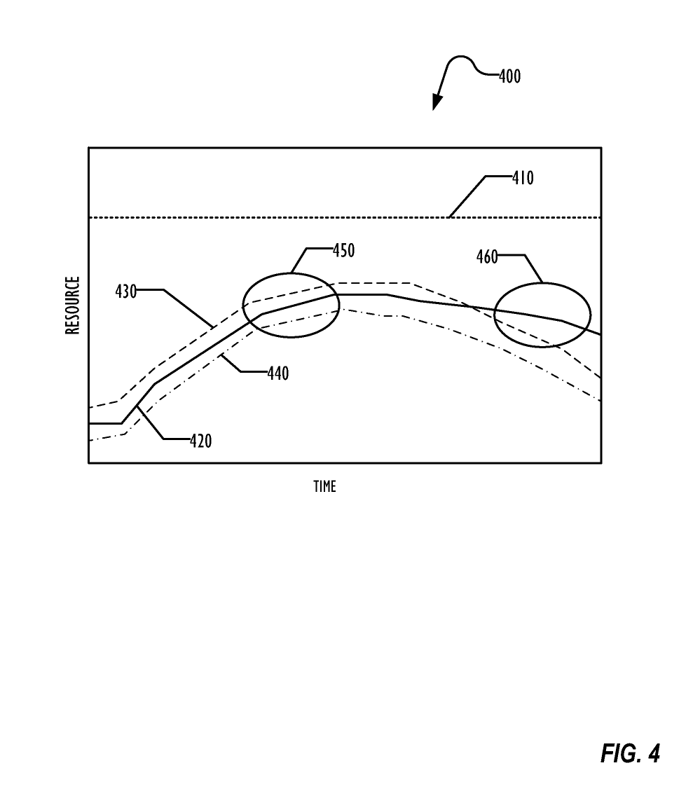

FIG. 4 illustrates a graph 400 in which an example metric curve 420 is compared with a threshold 410, and baseline curves 430 and 440. At area 450, for example, the metric curve is within the baseline curves 430 and 440, thus predictions may be omitted. In area 460, because the metric curve is outside the baselines 430 and 440, predictions may be made on whether the metric curve trends toward crossing the threshold 410. Merely being outside the baseline curves may be insufficient to indicate that the metric trends toward a threshold violation. As illustrated in FIG. 4, the metric curve 420 in area 460 is actually trending away from the threshold 410, even though it is above the baseline curve 430 and sloping away from the baseline curve 430. Thus, the prediction algorithm would typically not predict that the metric curve 420 is in danger of violating the threshold 410. In one embodiment, however, any deviation outside of the baseline range of curves 430 and 440 may be sufficiently interesting as to generate an alert to the operator, even if the prediction technique does not predict a violation of the threshold 410.

Various embodiments may calculate baseline curves in different ways, including discrete stepped baseline curves based on sampled data in which the baseline curves remain the same value throughout any measurement period, such as an hour, but may vary during different measurement periods. For example, in such an embodiment, the low and high baseline curves may be calculated once hourly, creating non-continuous stepped curves. Continuous curves, similar to the curves illustrated in FIGS. 2 and 3 may also be used in some embodiments, but are more resource intensive to produce.

In one embodiment, an exponentially weighted moving average (EWMA) may be used in the baseline calculations. Computation of the future baseline may be done by calculating the EWMA on the high and low components of the data, where each component value is a statistical determination of a 90th percentile and a 10th percentile of the data. Other techniques may be for calculating the baseline curves.

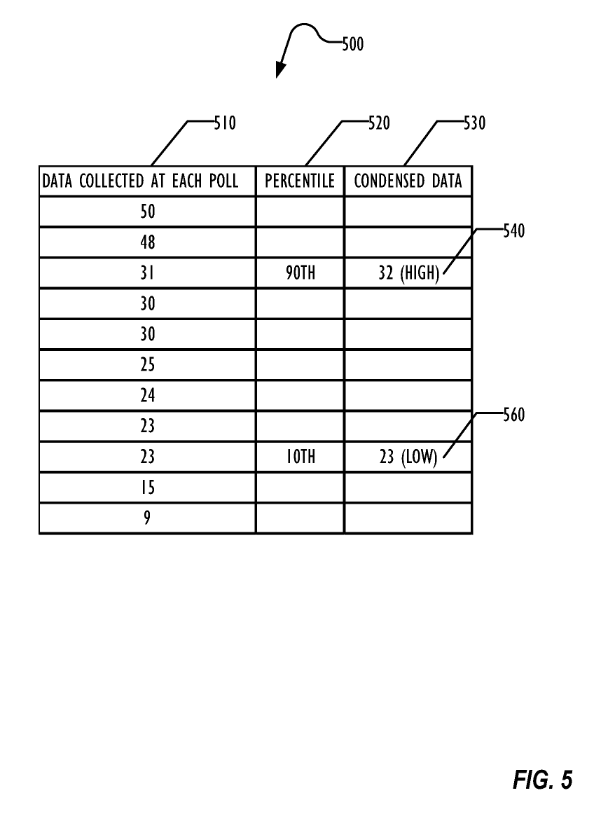

FIG. 5 illustrates a table 500 with example data values collected in this example every five minutes during an hourly period. Column 510 illustrates the collected values, column 520 illustrates the percentile value, and column 530 illustrates the condensed data points at the corresponding percentiles. The condensed high data value 540 is 32 and the condensed low data value 560 is 23. The condensed high data value 540 is not an actual data value that was collected during the collection period. In some embodiments, the condensed data values 540 and 560 may be limited to values that are in the collected data. Although the example table only uses two condensed data values for calculating the baseline curves, additional condensed data values may be used for the calculation if desired.

The baseline values may be computed on a periodic basis, such as hourly, daily, monthly, etc. In one embodiment, the baseline values may be computed at the end of each hour as follows, although in other embodiments an hourly computation may be performed at any consistent point during the hour as desired.

Data for the metric curve 120 may be collected over a one-hour period. The collected data may then be condensed at the end of the hour into condensed data points. In one embodiment, the data is condensed for each hour into low and high data points, using standard percentile calculations. In one embodiment, the low data point is determined by the lower 10th percentile of data for the preceding hour, so that 10% of the data points collected are below the low data point value. A similar calculation is performed to obtain the high value (at the 90th percentile). The percentile values are illustrative and by way of example only, and other percentiles may be used as desired. Similarly, other techniques for determining a high and low condensed data value for the preceding hourly data may be used.

The condensed data from the past hour and the previously computed baseline values for the past hour may then be used to calculate a baseline for the same hour of the following day, weighting the old data and the new data. In one embodiment, the following equation may be used to weight the moving average:

future=old*0.75+current*0.25

where “future” is the baseline value for the future period, “old” is the previous baseline value, and “current” is the condensed data for the past hour. In one embodiment, this calculation may be performed once for each of the low and high values, to compute a future low and high baseline. The equation used to calculate the future baseline values and the constants used above to weight the old and current values are illustrative and by way of example only. Other constants may be used as desired, and other equations may be used to calculate the future baseline values from the old and current values.

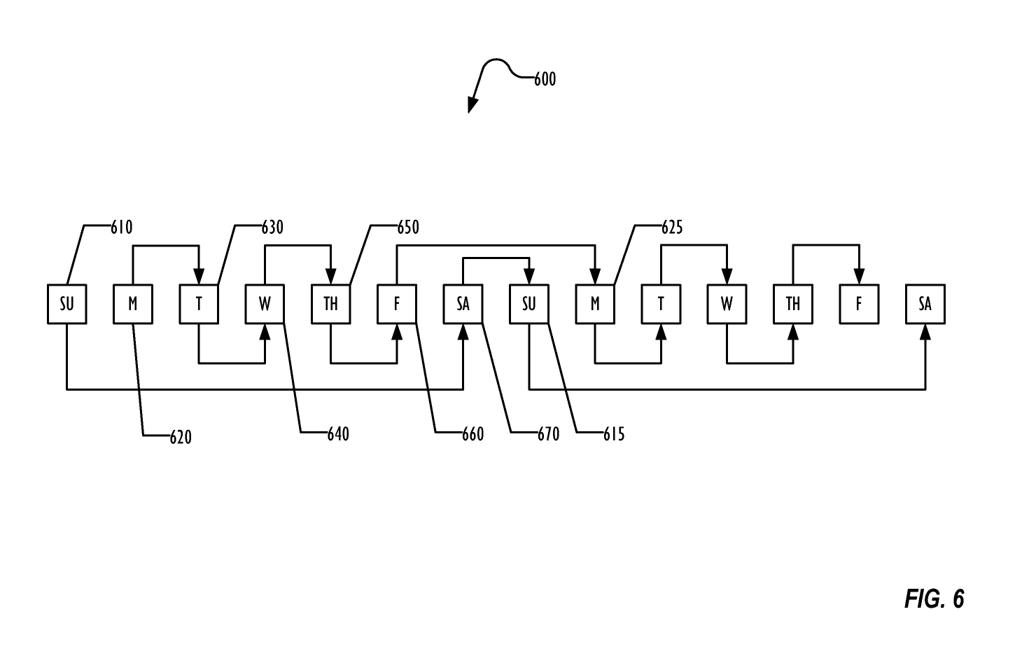

In one embodiment, the calculations may be split into weekday and weekend calculations. Thus, as illustrated in FIG. 6, calculations on Sunday (610) are used to create the baseline values for the following Saturday (670), and calculations on Saturday are used to create the baseline values for the following Sunday (615). Calculations on Monday (620) are used to create a baseline for Tuesday (630), Tuesday (630) for Wednesday (640), Wednesday (640) for Thursday (650), Thursday (650) for Friday (660), and Friday (660) for the following Monday (625), where the cycle begins again. This allows generating baselines that may account for differences in activity on weekdays and weekends. In other embodiments, separate baselines may be created for each individual day of the week. In other embodiments, the above separation of weekdays and weekends may be omitted, creating a single baseline curve for the week.

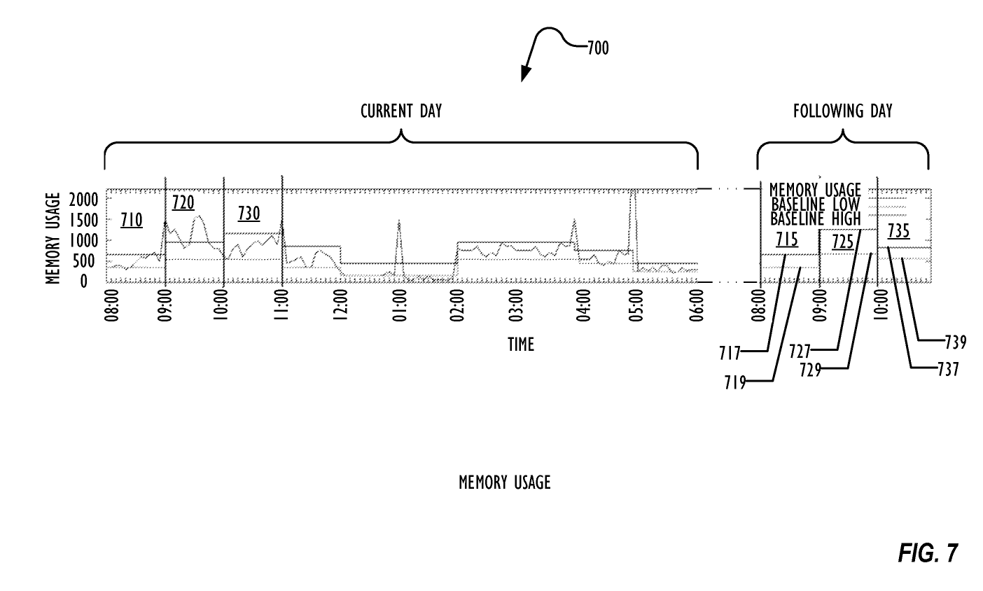

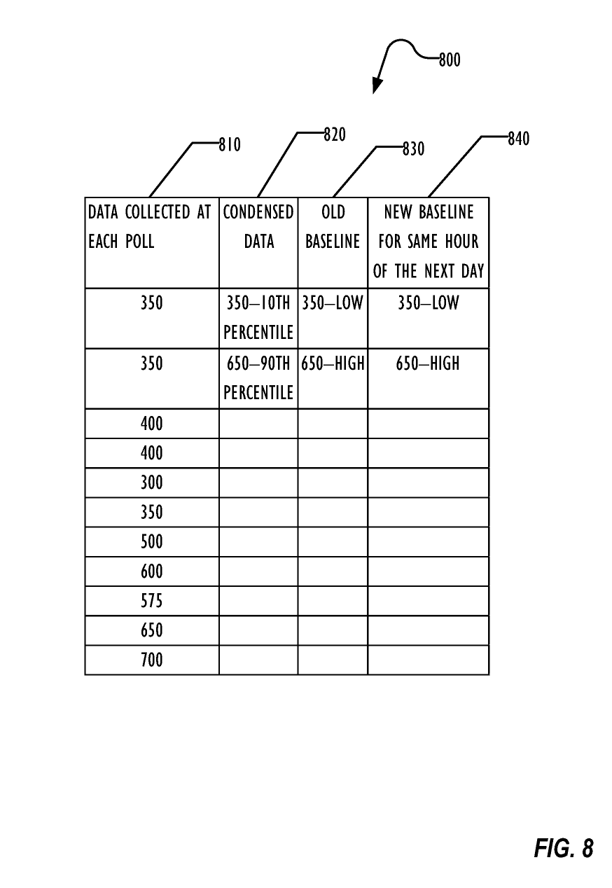

FIG. 7 is a graph illustrating a metric 700, here “memory usage,” and illustrates how the baseline in each hourly window is used to set the baseline for the same hour in the next day. FIG. 8 is a table 800 that illustrates how the baseline computed in window 710 (8:00-9:00 AM of one day) is used to set the baseline for the window 715 (8:00-9:00 AM the following day). Column 810 illustrates the data points, in this example collected every five minutes during the hour of window 710. Column 820 illustrates the condensed data points, in this embodiment, calculating only values for high and low baselines, using 90th and 10th percentiles. Column 830 illustrates the old baseline values for the window 710. Column 840 illustrates the new baseline values for the window 715. In this example, the condensed data 820 and the old baseline values 830 are the same, so the new baseline values 840 in window 715 are the same as the baselines in window 710. in window 715. The new baselines are illustrated in FIG. 7 by lines 717 and 719.

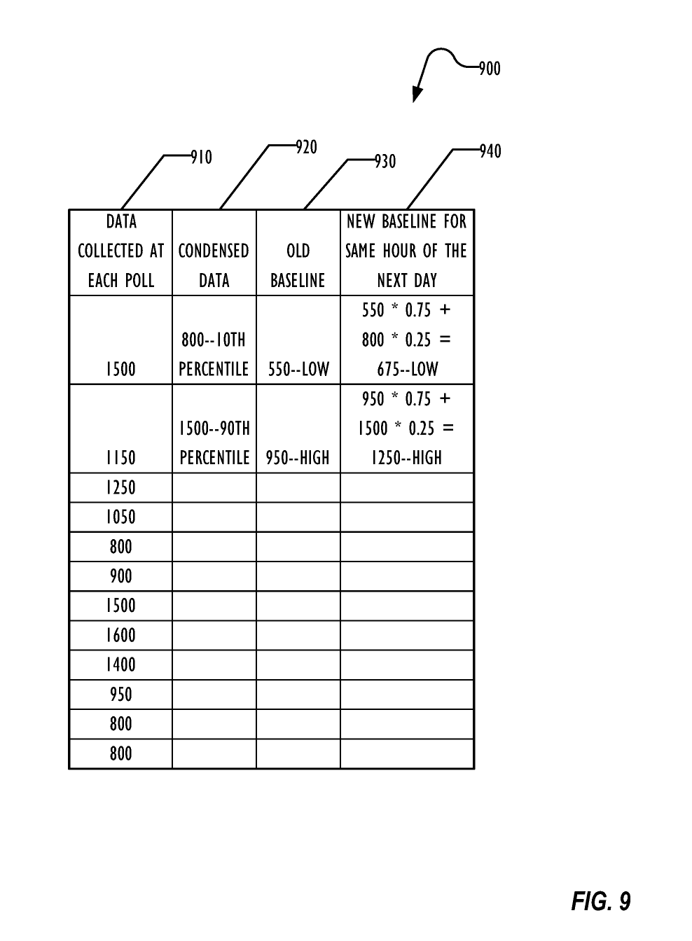

The baseline computed in window 720 (9 AM-10 AM) is set as the baseline for the window 725 (9 AM-10 AM the next day). FIG. 9 is a table 900 that illustrates how the baseline computed in window 720 (9-10 AM the current day) is used to set the baseline for the window 725 (9-10 AM the following day). Column 910 illustrates the data points, in this example collected every five minutes during the hour of window 720. Column 920 illustrates the condensed data points, in this embodiment, calculated at the 90th and 10th percentiles. Column 930 illustrates the old baseline values for the window 720. Column 940 illustrates the new baseline values for the window 725. As illustrated in FIG. 9, the old low baseline value in window 720 is 550, the old high baseline value in window 720 is 950, the new low baseline value is calculated as 675, and the high baseline value is calculated as 1250, using the equation described above. These new high and low baseline values are illustrated by lines 727 and 729 in FIG. 7.

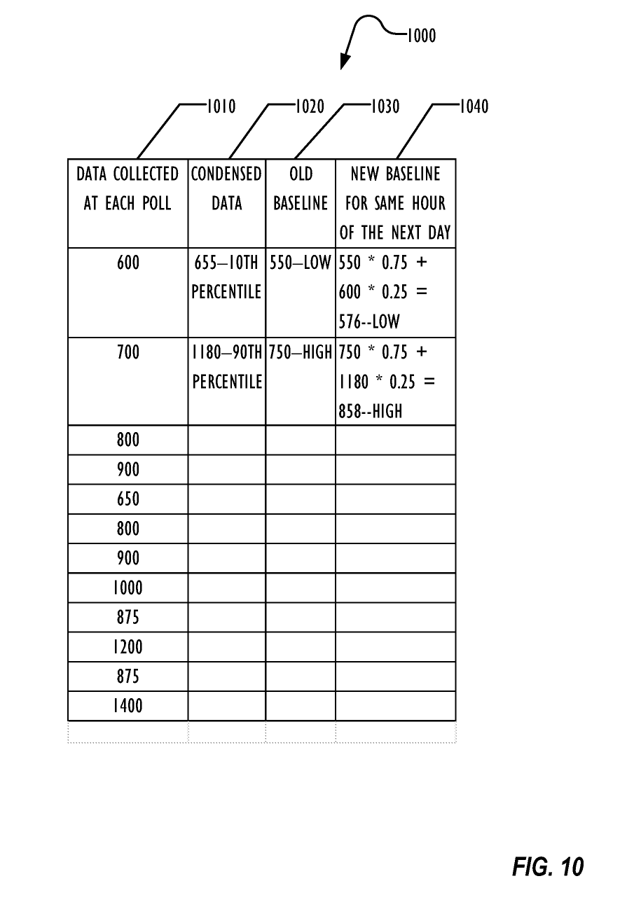

The baseline computed in window 730 (10 AM-11 AM) is set as the baseline for the window 735 (10 AM-11 AM the next day). FIG. 10 is a table 1000 that illustrates how the baseline computed in window 730 is used to set the baseline for the window 735. Column 1010 illustrates the data points, in this example collected every five minutes during the hour of window 730. Column 1020 illustrates the condensed data points, in this embodiment, calculated at the 90th and 10th percentiles. Column 1030 illustrates the old baseline values for the window 730. Column 1040 illustrates the new baseline values for the window 735. As illustrated in FIG. 10, the old low baseline value in window 730 is 550, the old high baseline value in window 730 is 750, the new low baseline value is calculated as 576, and the high baseline value calculated as 858, using the equation described above. These new high and low baseline values are illustrated by lines 737 and 739 in FIG. 7.

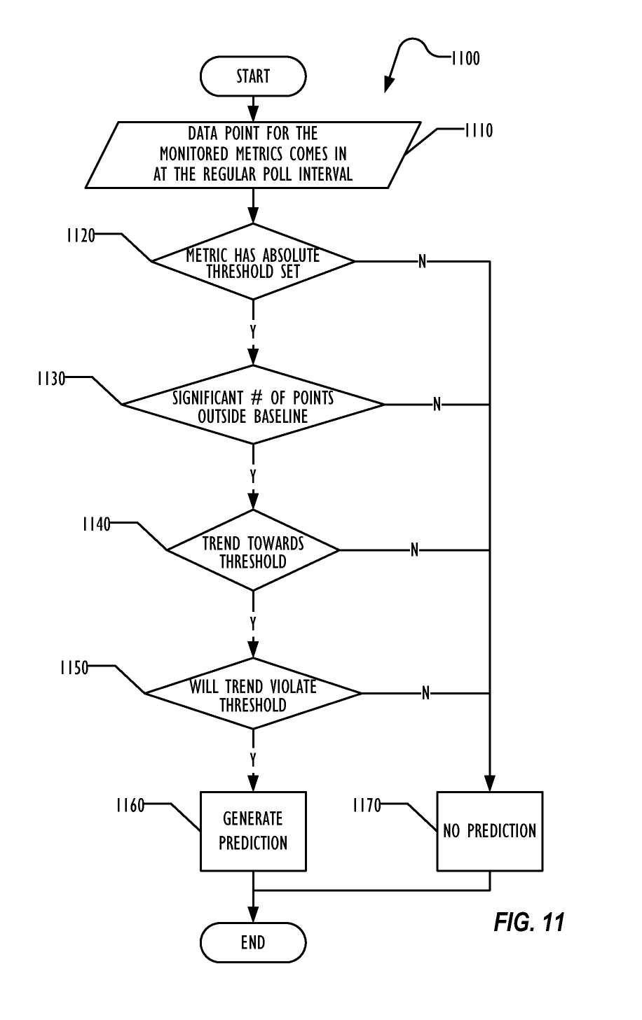

FIG. 11 is a flowchart 1100 illustrating a technique for determining whether to predict if a trend of the metric is likely to violate a threshold value according to one embodiment. Any metric with may be monitored and data collected for the metric in block 1110, typically at regular intervals that subdivide a measurement period. The data collected at each interval may be processed in real time to make the predictions. In block 1120, if the metric is not one with an absolute threshold, then the technique may omit making prediction. In other embodiments, in which predictions are made if the metric has a dynamic threshold, decision block 1120 may be omitted. Every data point that is collected during the measurement period may be checked in block 1130 against the baseline for that measurement period. In one embodiment, a prediction may be omitted unless a statistically significant number of data points are outside the baseline values. Any desired technique for determining whether the number of data points outside the baseline values is statistically significant may be used. In other embodiments, a prediction may be desired if some data points are outside of the baseline values, regardless of the statistical significance of the number of such data points. In block 1140, if the short-term trend in the data is not trending towards the threshold, then no prediction is needed. For example, in the metric graph illustrated in FIG. 4, no prediction is needed in the measurement period indicated by area 460, because the metric is trending away from the threshold 410. By omitting prediction analysis if the trend is not towards to threshold, the technique may improve performance of the performance monitoring system, by eliminating the need to make predictions and generated alerts. In block 1150, if the trend in the metric data indicates that the metric may violate the threshold set for that metric, then in block 1160, a prediction is generated, typically to alert an operator of the threshold violation. Otherwise, no prediction is necessary.

As described above, only the high and low condensed data points are used in the calculation of new baselines or in the decision of whether to generate a prediction. In some embodiments, where more than a high/low pair of condensed data values are calculated, the other condensed data values may also be included in the calculation of the new baseline values, in the determination of whether a number of data points outside of the baseline values is statistically significant, or both.

Any desired technique known to the art may be used to perform the trend analysis and make the prediction of whether the trend indicates a likelihood of a threshold violation.

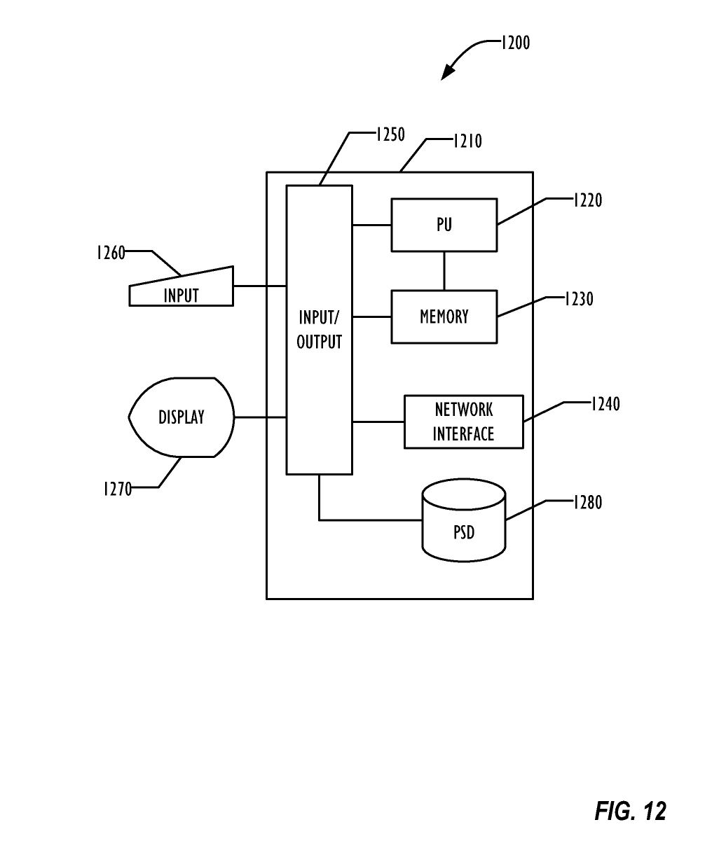

Referring now to FIG. 12, an example computer 1200 for use in analyzing metric data is illustrated in block diagram form. Example computer 1200 comprises a system unit 1210 which may be optionally connected to an input device or system 1260 (e.g., keyboard, mouse, touch screen, etc.) and display 1270. A program storage device (PSD) 1280 (sometimes referred to as a hard disc) is included with the system unit 1210. Also included with system unit 1210 is a network interface 1240 for communication via a network with other computing and corporate infrastructure devices (not shown). Network interface 1240 may be included within system unit 1210 or be external to system unit 1210. In either case, system unit 1210 will be communicatively coupled to network interface 1240. Program storage device 1280 represents any form of non-volatile storage including, but not limited to, all forms of optical and magnetic, including solid-state, storage elements, including removable media, and may be included within system unit 1210 or be external to system unit 1210. Program storage device 1280 may be used for storage of software to control system unit 1210, data for use by the computer 1200, or both.

System unit 1210 may be programmed to perform methods in accordance with this disclosure (an example of which is in FIG. 11). System unit 1210 comprises a processor unit (PU) 1220, input-output (I/O) interface 1250 and memory 1230. Processing unit 1220 may include any programmable controller device including, for example, one or more members of the Intel Atom®, Core®, Pentium® and Celeron® processor families from the Intel and the Cortex and ARM processor families from ARM. (INTEL, INTEL ATOM, CORE, PENTIUM, and CELERON are registered trademarks of the Intel Corporation. CORTEX is a registered trademark of the ARM Limited Corporation. ARM is a registered trademark of the ARM Limited Company.) Memory 1230 may include one or more memory modules and comprise random access memory (RAM), read only memory (ROM), programmable read only memory (PROM), programmable read-write memory, and solid-state memory. One of ordinary skill in the art will also recognize that PU 1220 may also include some internal memory including, for example, cache memory.

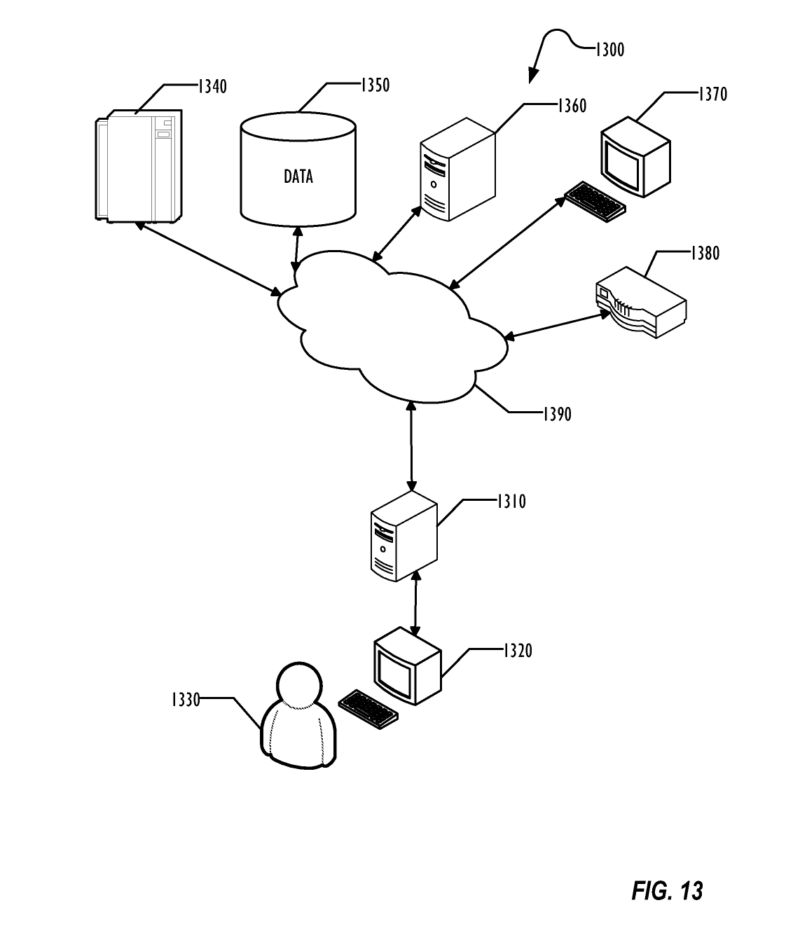

FIG. 13 is a block diagram illustrating an example IT infrastructure system 1300 that employs performance monitoring using the techniques described above. An application executing in computer 1310 may collect and monitor performance data from a number of IT infrastructure system elements, including a mainframe 1340, a data storage system 1350, such as a storage area network, a server 1360, a workstation 1370, and a router 1380. As illustrated in FIG. 13, the infrastructure system 1300 uses a network 1390 for communication of monitoring data to the monitoring computer 1310, but in some embodiments, some or all of the monitored devices may be directly connected to the monitoring computer 1310. These system elements are illustrative and by way of example only, and other system elements may be monitored. For example, instead of being standalone elements as illustrated in FIG. 13, some or all of the elements of IT infrastructure system 1300 monitored by the computer 1310, as well as the computer 1310, may be rack-mounted equipment. Although illustrated in FIG. 13 as a single computer 1310, multiple computers may provide the performance monitoring functionality described above.

In some embodiments, an operator 1330 uses a workstation 1320 for viewing displays generated by the monitoring computer 1310, and for providing functionality for the operator 1330 to take corrective actions when an alarm is triggered. In some embodiments, the operator 1330 may use the computer 1310, instead of a separate workstation 1320.

Various changes in the components as well as in the details of the illustrated operational method are possible without departing from the scope of the following claims. For instance, the illustrative system of FIG. 12 may be comprised of more than one computer communicatively coupled via a communication network, wherein the computers may be mainframe computers, minicomputers, workstations or any combination of these. Such a network may be composed of one or more local area networks, one or more wide area networks, or a combination of local and wide-area networks. In addition, the networks may employ any desired communication protocol and further may be “wired” or “wireless.” In addition, acts in accordance with FIG. 11 may be performed by a programmable control device executing instructions organized into one or more program modules. A programmable control device may be a single computer processor, a special purpose processor (e.g., a digital signal processor, “DSP”), a plurality of processors coupled by a communications link or a custom designed state machine. Custom designed state machines may be embodied in a hardware device such as an integrated circuit including, but not limited to, application specific integrated circuits (“ASICs”) or field programmable gate array (“FPGAs”). Storage devices suitable for tangibly embodying program instructions include, but are not limited to: magnetic disks (fixed, floppy, and removable) and tape; optical media such as CD-ROMs and digital video disks (“DVDs”); and semiconductor memory devices such as Electrically Programmable Read-Only Memory (“EPROM”), Electrically Erasable Programmable Read-Only Memory (“EEPROM”), Programmable Gate Arrays and flash devices.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A method comprising:
collecting data by a computer-implemented performance monitoring system corresponding to a metric of an information technology system;
setting a threshold value corresponding to the metric;
generating a baseline corresponding to the metric; and
generating a prediction that the metric will violate the threshold only if at least some of the data corresponding to the metric are outside of the baseline.

2. The method of claim 1, wherein the act of generating a baseline comprises:
generating a first baseline value for a measurement period corresponding to a first condition; and
generating a second baseline value for the measurement period corresponding to a second condition, wherein the first baseline value and the second baseline value define a baseline range for the measurement period.

3. The method of claim 1, wherein the act of generating a prediction that the metric will violate the threshold only if the data corresponding to the metric is outside of the baseline comprises:
generating a prediction that the metric will violate the threshold only if a statistically significant number of data values collected during a measurement period corresponding to the metric are outside of the baseline.

4. The method of claim 1, wherein the act of generating a baseline corresponding to the metric comprises:
calculating a baseline using an exponentially weighted moving average of the metric.

5. The method of claim 1, wherein the act of generating a baseline corresponding to the metric comprises:
condensing data values collected during a first measurement period into a first condensed value having a first relationship to the data values collected during the first measurement period; and
calculating a first baseline value for a second measurement period using a first baseline value for the first measurement period and the first condensed value.

6. The method of claim 5, wherein the act of condensing data values comprises:
calculating a first condensed value as a first percentile of the data values collected during the first measurement period.

7. The method of claim 5, wherein the act of calculating a first baseline value comprises:
calculating a first baseline value for a second measurement period occurring at the same time a following day as the first measurement period.

8. The method of claim 5, wherein the act of calculating a first baseline value comprises:
calculating a first baseline value for a second measurement period occurring at the same time a following weekend day as the first measurement period.

9. The method of claim 5, wherein the act of generating a baseline corresponding to the metric further comprises:
condensing data values collected during the first measurement period into a second condensed value having a second relationship to the data values collected during the first measurement period; and
calculating a second baseline value for the second measurement period using a second baseline value for the first measurement period and the second condensed value.

10. The method of claim 9, wherein the act of condensing data values collected during the first measurement period into a second condensed value having a second relationship to the data values collected during the first measurement period comprises:
calculating a second condensed value as a second percentile of the data values collected during the first measurement period.

11. The method of claim 1, wherein the act of generating a prediction that the metric will violate the threshold only if the data corresponding to the metric is outside of the baseline comprises:
calculating a trend of the data corresponding to the metric collected during a measurement period; and
generating a prediction that the metric will violate the threshold only if the data corresponding to the metric is outside of the baseline and the trend is toward the threshold.

12. A performance monitoring system, comprising:
a processor;
an operator display, coupled to the processor;
a storage subsystem, coupled to the processor; and
a software, stored by the storage subsystem, comprising instructions that when executed by the processor cause the processor to perform the method of claim 1.

13. A non-transitory computer readable medium with instructions for a programmable control device stored thereon wherein the instructions cause a programmable control device to perform the method of claim 1.

14. A networked computer system comprising:
a plurality of computers communicatively coupled, at least one of the plurality of computers programmed to perform at least a portion of the method of claim 1 wherein the entire method of claim 1 is performed collectively by the plurality of computers.

15. A method, comprising:
collecting data by a computer-implemented performance monitoring system corresponding to a metric of an information technology system during a first measurement period;
setting a threshold value corresponding to the metric;
generating a first baseline value for the first measurement period corresponding to a first condition;
generating a second baseline value for the first measurement period corresponding to a second condition, wherein the first baseline value and the second baseline value define a baseline range for the first measurement period;
calculating a trend of the data corresponding to the metric collected during a measurement period; and
generating a prediction that the metric will violate the threshold only if a statistically significant number of data values collected during the first measurement period corresponding to the metric are outside of the baseline range and the trend is toward the threshold.

16. The method of claim 15, further comprising:
condensing data values collected during the first measurement period into a first condensed value calculated as a first percentile of the data values collected during the first measurement period;
condensing data values collected during the first measurement period into a second condensed value calculated as a second percentile of the data values collected during the first measurement period;
calculating a third baseline value for a second measurement period using the first baseline value for the first measurement period and the first condensed value; and
calculating a fourth baseline value for the second measurement period using the second baseline value for the first measurement period and the second condensed value.

17. The method of claim 16, wherein the act of calculating a third baseline value and the act of calculating a fourth baseline value are performed for a second measurement period that is at the same time as the first measurement period on a following day.

18. A method, comprising:
collecting data by a computer-implemented performance monitoring system corresponding to a metric of an information technology system during a first measurement period;
generating a first baseline value for the first measurement period corresponding to a first condition;
generating a second baseline value for the first measurement period corresponding to a second condition, wherein the first baseline value and the second baseline value define a baseline range for the first measurement period;
calculating a third baseline value for a second measurement period responsive to the first baseline value for the first measurement period and the data collected during the first measurement period; and
calculating a fourth baseline value for the second measurement period responsive to the second baseline value for the first measurement period and data collected during the first measurement period.

19. The method of claim 18, wherein the act of calculating a third baseline value comprises:
calculating a third baseline value for a second measurement period as an exponentially weighted moving average of the first baseline value for the first measurement period and a first percentile of the data values collected during the first measurement period.

20. The method of claim 18, further comprising:
setting a threshold value corresponding to the metric;
calculating a trend of the data corresponding to the metric collected during the first measurement period; and
generating a prediction that the metric will violate the threshold only if a statistically significant number of data values collected during the first measurement period corresponding to the metric are outside of the baseline range and the trend is toward the threshold.
